(19) United States
(12) Patent Application Publication
(10) Pub. No.: US 2004/0250070 A1
(43) Pub. Date: Dec. 9, 2004

(54) Authentication of electronic documents

(76) Inventor: Yaw Ming Wong, Singapore (SG)

Correspondence Address: Darin J Gibby, Townsnd and Townsend and Crew, Two Embarcadero Center, 8th Floor, San Francisco, CA, 94111, US

(21) Appl. No.: 10/488,561

(22) PCT Filed: Sep. 3, 2002
(86) PCT No.: PCT/SG02/00204

(30) Foreign Application Priority Data
Sep. 3, 2001 (SG) 200105438-6

(51) Int. Cl. H04L 9/00

(52) U.S. Cl. 713/170

(57) ABSTRACT

A method and system for creation and storage of authenticated documents on behalf of a wide range of content owners, such as a party to a contract, or an organisation requiring an electronic resolutions by members of the organisation. Content for a document is received from the owner then converted to a non-editable form suitable for online display. One or watermarks may be added representing the owner and/or the holder of the authenticated document. Participants in a process authorised by the owner then access the document online and indicate approval or otherwise add digital signatures to the document. A date and time/stamps is generally added with each signature. Once the process is complete the document is generally stamped again, encrypted and stored for later inspections. Participants receive a token that enables watermarks in the document viewed on line to be checked before signature.

### FIELD OF THE INVENTION

This invention relates to systems for authentication and storage of electronic documents, in particular but not only to systems in which documents are digitally signed and accessed over a communications network such as the Internet.

### BACKGROUND TO THE INVENTION

Business is increasingly conducted over the Internet and other electronic communication networks. Many organisations are carrying out their internal and external operations using electronic rather than manual documentation to form contracts and other agreements. New procedures involving encryption through Public Key Infrastructure (PKI), digital signatures and certificates, and watermarks are available to assist in processes involving electronic documents. There is a need for “trusted entities” through whom business actions can be authenticated and made accessible over the Internet to approved participants in business processes.

### SUMMARY OF THE INVENTION

It is an object of the present invention to provide systems for authentication and storage of electronic documents on the Internet through a trusted entity, or at least to provide an alternative to existing systems. In general terms, the invention includes a system in which a trusted original document may be accessed and digitally signed by participants in a business process, and then stored on behalf of an owner of the document.

In one aspect the invention may broadly be said to consist in a method of processing an electronic document for signature and authentication, comprising: receiving a document to be signed by one or more participants, adding a confidence mark to the document, providing the marked document for the participants, receiving and authenticating signatures of the participants to the marked document, and storing the signed document. Preferably the method further comprises adding a second confidence mark to the document, with one mark indicating a creator or owner of the document, and the other mark indicating an entity that carries out the method on behalf of the owner.

In another aspect the invention also comprises a method of signing an electronic document, comprising: receiving the document from an entity over a communications network, extracting a confidence mark from the document, verifying the confidence mark as indicating the origin of the document, presenting a verification of the confidence mark to a participant signatory, creating a digital signature of the participant, and transmitting the signature to the entity. Preferably the method further comprises extracting a second confidence mark from the document, verifying the second confidence mark, and thereby obtaining an indication of both a creator or owner of the document and of the entity.

In further aspects the invention also comprises computer readable media containing program instructions for implementing methods according to either of the aspects set out above.

### LIST OF FIGURES

Preferred embodiments of the invention will be described with respect to the drawings, of which:

FIG. 1 schematically shows a trusted entity, a document owner, and a number of participants who may be part of a business process involving signature of the document over a communications network,

FIG. 2 outlines operation of a computer system operated by a trusted entity when acting for the document owner in relation to the participants,

FIG. 3 outlines how one or more confidence marks such as watermarks may be added to the document,

FIG. 4 outlines a process operated by the entity by which the participants may electronically sign a document in the process of FIG. 2,

FIG. 5 outlines a process operated by a participant at a respective computer terminal during signature of a document,

FIG. 6 indicates an interface that might be presented to the participant at the respective computer terminal, and

FIGS. 7 and 8 indicate data held by the entity in relation to a number of owners for whom electronic documents are authenticated and stored.

### DETAILED DESCRIPTION OF PREFERRED EMBODIMENTS

Referring to the drawings it will be appreciated that the invention may be implemented in many ways, and this description is given by way of example only. The operation of computer networks such as the Internet, encryption systems such as PKI, and of certification systems such as provided by Verisign and other international certification authorities, will be appreciated by a skilled reader and details need not be given.

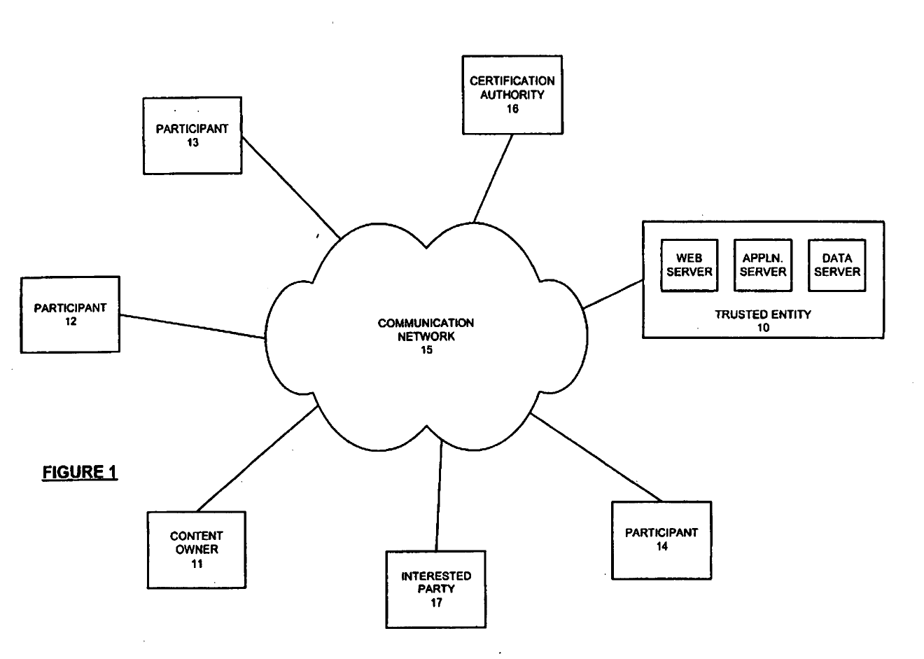

FIG. 1 schematically shows a trusted entity 10 that provides authentication and storage of a document on behalf of a content creator or owner 11, in relation to a number of participants 12, 13, 14 in a process involving the document. The content owner could be an organisation such as a company for example, with the participants being directors or other members of the company who are required to make resolutions using documents prepared by a company secretary. The content owner transmits the document over a network 15 to the trusted entity along with various details such as identities of the participants. Each of the participants has access to a computer terminal which may be connected to the entity through the communications network, typically the Internet, a virtual private network (VPN), or perhaps a local network. All connections are preferably made using a secure sockets layer system (SSL). A server system at the entity may include a web server, application server and a data server, for example, and the participant terminals would then typically include software such as browsers which are able to interact with the servers. The participant terminals are also provided with hardware and/or software components that enable signature of electronic documents and other operations involving digital certificates and watermarks. The hardware components may include a card reader system for example while software components may be incorporated in the browser, preferably provided to the participants by the entity on instruction from the content owner.

FIG. 1 also shows a certification authority 16 that is typically responsible for generation of public and private keys for the entity and the participants, and digital certificates. The authority is also generally connected to the communications network 15 for convenient interactions with the various parties as required to enable PKI and other standard authentication functions. Many authorities of this kind are currently active around the world. An interested party 17 such as a financial organisation or Registrar of Companies is also indicated. Such a party may for various reasons wish online access to the records created by the content owner and the participants.

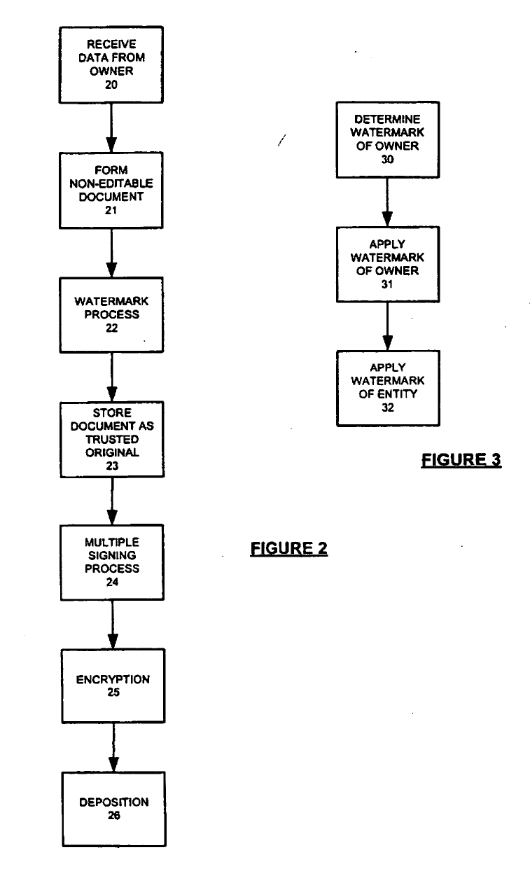

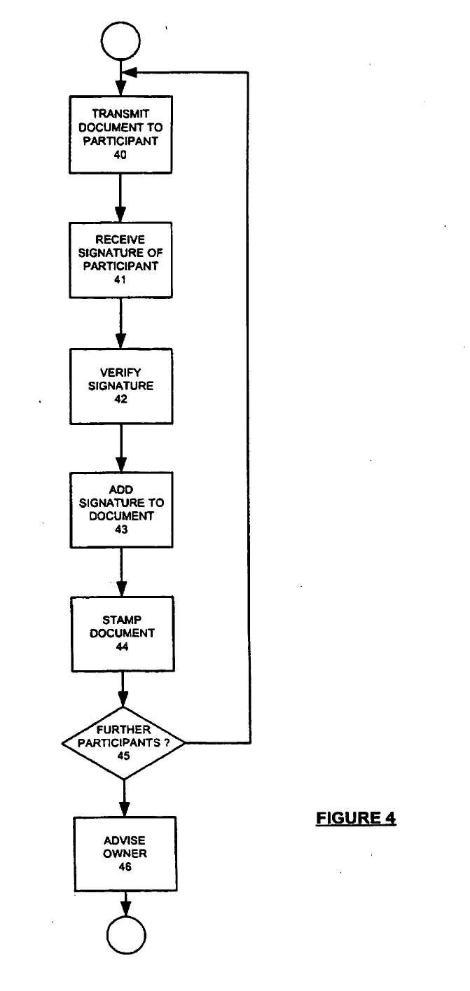

FIG. 2 shows a series of operations carried out by the trusted entity 10 when interacting with the content owner 11 and the participants in FIG. 1. In step 20 the entity receives and stores an electronic document from the owner, and perhaps other data verifying the owner and relating to a process associated with the document. A document in this sense can take a broad range of content and format, including a data stream. More conventionally the document could be a file created by a common word, data or graphics processor in a format such as MSWord, Excel, JPEG, GIG, or HTML. It could also be generated within the entity operating on its own behalf. In step 21, the document is preferably converted to a substantially non-editable form such as an image in TIFF or Acrobat PDF. A hardening process of this kind reduces the likelihood of tampering with the content. A confidence mark is then applied in step 22, perhaps using a watermark provided by the content owner or the entity, as described in relation to FIG. 3. These steps may be applied in a different order in some cases. The hardened, marked document is then stored by the entity as a trusted electronic original in step 23. Meanwhile participants in a process related to the document have been advised, typically by the content owner although possibly by the entity, that the document is available for review and signature. A signing process takes place in step 24 as described in relation to FIG. 4. Once the signing process is complete, assuming it has not terminated for some other reason, the document is encrypted by the trusted entity in step 25 and stored or otherwise deposited in step 26 in a secure location, generally operated by the entity, for future purposes. The encryption process preferably uses a public key of the content owner, as provided by the certification authority, for example. The owner may be advised by the entity regarding the status of the process and the document at one or more suitable points in time.

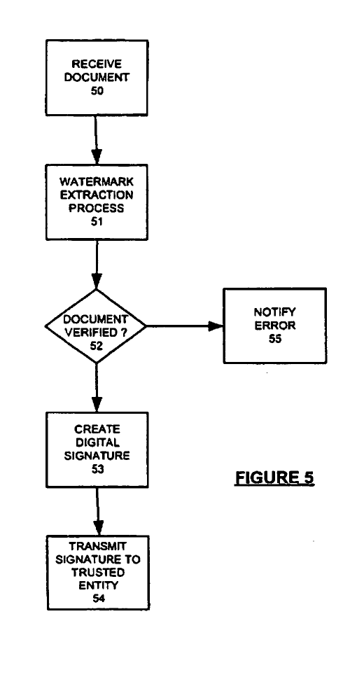

FIG. 3 shows a preferred form of the process in FIG. 2 by which one or more confidence marks are added to the document held by the trusted entity. A confidence mark is generally but not necessarily a watermark or some other transformation of the document commonly used for marking digital content. It is generally non-intrusive and non-reversible, and may or may not be visible to a reader. However, an indication of the watermark can usually be extracted from the document given knowledge of the transformation process by which the watermark was applied. A confidence mark representing either of the content creator or owner, or the trusted entity may be applied. Preferably two marks representing both of these parties are applied. The participants are preferably able to detect and verify marks by one or other or both of these parties as described in relation to FIG. 5. In step 30 of the double marking process of FIG. 3, the entity first retrieves a watermark provided by the content owner, either with the particular document, or at some other point perhaps much earlier as part of an ongoing relationship between the parties. The owner's watermark is then applied to the document in step 31 and the entity's watermark in step 42. It will appreciated that watermarking can take place in a wide variety of ways, such as modification by way of least significant bits or discrete cosine transformation, and that yet other ways may be developed in future.

FIG. 4 shows a preferred form of the signing process in FIG. 2 by which the participants in FIG. 1 receive copies of the electronic document and add digital signatures or otherwise approve the content. The participants typically access a web server operated by the trusted entity over the Internet, although any other suitable form of communication may take place, such as an email transfer for example. In step 40 a copy of the original document, preferably in a hardened, watermarked form, is transmitted to a participant who carries out a process such as described in FIG. 5. A digital signature or other notification is received from the participant in step 41 and verified in step 42. A digital signature accompanied by a digital certificate from an authority 17 is currently a common mechanism for this process and other processes may of course exist or be developed. The entity then adds the signature to the original document in a suitable way in step 43, also adding a date/time stamp in step 44. Data of this kind might also be stored separately but this is currently considered less reliable than a close association between document and data in an electronic binder. The entity is generally advised or otherwise aware regarding the number of participants that are expected to sign the original document, or may be in ongoing communication with the content owner for this purpose. In step 45 the entity determines that the signing process is complete, and may or may not advise the owner in step 46.

FIG. 5 outlines part of the typical function of a token at a computer terminal operated by a participant during the signing process. Hardware/software tokens for purposes of this general kind are available from various sources such as Gemplus. In this case, the token has been modified to meet the needs of the process operated by the trusted entity, and distributed by the entity to the respective participants. For example, the token may contain routines for SSL or other encrypted interactions with the entity, and a record of one or watermarks which may be applied by the entity in relation to particular documents. In some cases the token may be provided as solely in browser software downloaded by the participant from the trusted entity. Data of this kind, along with the software programs that operate the participant processes, are stored, accessed and operated in the usual way, using computer processors, networks, and memory devices or other computer readable media.

In FIG. 5, step 50, the participant either receives a document for signature, along with other details, either on request to or prompt by the trusted entity. In step 51 the token extracts one or more confidence marks from the document, typically watermarks applied by the entity to indicate either or both of the entity, and the owner or creator of the document. The watermarks may be assessed and verified visually by the participant, but preferably electronically by the token. A confidence indicator is generally presented to the participant as an indication of the origin of the document with the owner and/or the entity. If the origin is not satisfactorily verified in step 52, then an error message may be generated in step 55. If verified, then the participant may proceed to create a digital signature in step 53. Known process for digital signatures involve creating a hash of the document or other digital item, then encrypting the hash result using a private key. The hash result is unique to the content of the document, and once encrypted is unique to the owner of the private key. The digital signature may be decrypted using the corresponding public key and compared with a further hash result from the document. In general, this creates a non-repudiated binding relationship between the signatory and the document. The signature is transmitted to the entity in step 54, and may or may not be accompanied by other information.

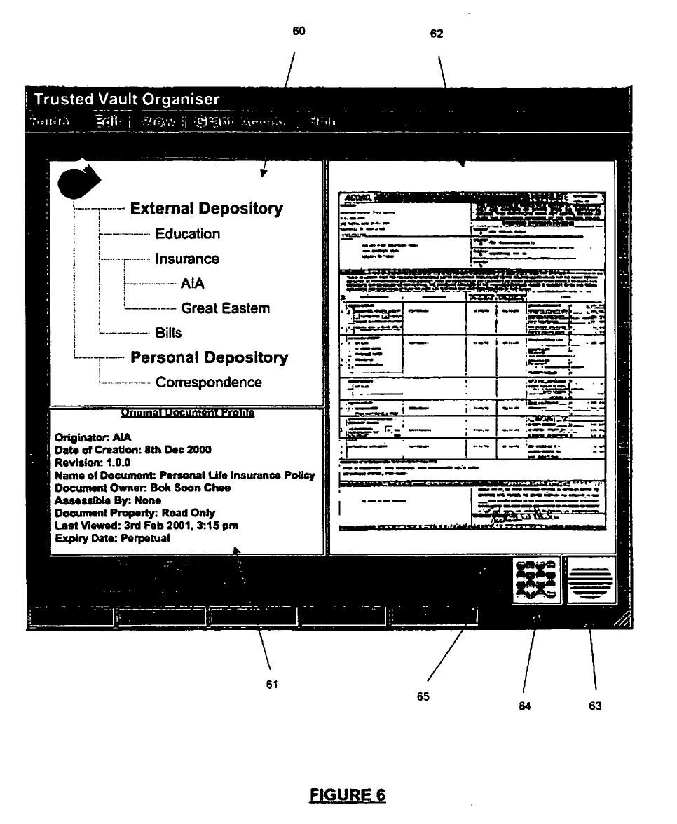

FIG. 6 illustrates a view as might be presented to a participant during the process of FIG. 5, usually as determined by a token provided by the entity. Details of the entity or other depository are displayed in an upper left portion 60 of the view. Details of the document, in this case an insurance policy, are displayed in a lower left portion 61. A page of the document itself is displayed in a right side portion 62, and may be scrolled or manipulated in various permitted ways. At lower right is an indication of a watermark 63 representing the owner or creator of the document, as extracted from the document by the token. This will generally be familiar to the participant, but may also be electronically verified. Also indicated is a further watermark 64 representing the entity as the source of the document, preferably also displayed and/or verified for the participant. A verification symbol 65 is indicated. The entity watermark may or may not be familiar or interpretable by the participant. On appropriate verification of the document by watermark or other means, the participant may proceed with a digital signature if the content of the document is approved. Non-approval of the document is managed by a process of the owner that need not be explained here. A wide range of views and operations may be offered or permitted for the participant in practice.

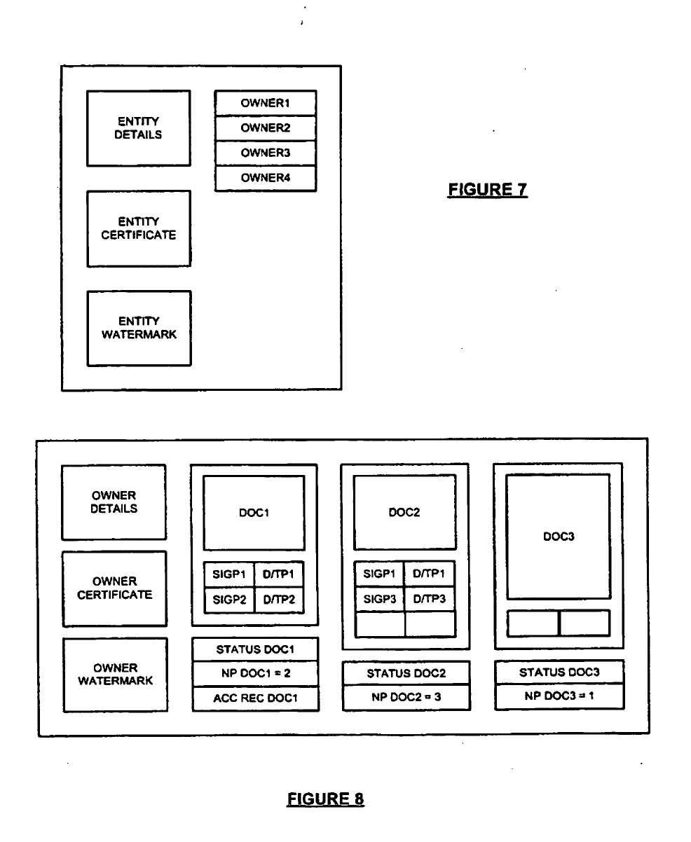

FIG. 7 is a general indication of data that is preferably held by the trusted entity 10 in FIG. 1, relating to a number of content owners or creators 11. The entity is known to the owners by prior arrangement, and records various details regarding the owners as required. A list of documents and required or authorised participants is generally held, for example. The entity also usually holds its own PKI data including public and private keys, and a digital certificate that verifies the public key, for electronic correspondence with the owners. The entity also holds a watermark. Data of this kind, along with the software programs that operate the entity processes, are stored, accessed and operated in the usual way, using computer processors, networks, and memory devices or other computer readable media.

FIG. 8 is a general indication of data that might be held by the entity in relation to a particular owner. Details of the owner for correspondence and billing purposes for example, a digital certificate including the owner's public key and a watermark supplied by the owner. Three documents are indicated in this example, at various stages of the process of FIG. 2. Document 1 has been signed by a required number NP of two participants SIGP1, SIGP2, including date/time stamps D/TP1, DTP2, and has a completed status. It may be available for access by the owner or other parties, in which case an access record will be generally be kept. Document 2 is awaiting a third of three required signatures and has a status of incomplete. Document 3 has not yet been hardened, watermarked or signed, and has a status of new.

1. A method of processing an electronic document for signature and authentication, comprising:
receiving a document to signed by one or more parties,
adding a confidence mark to the document,
providing the marked document for the parties,
receiving and authenticating signatures of the parties to the marked document, and storing the signed document.

2. A method according to claim 1 further comprising:
date/time stamping the document after receiving the document for signature.

3. A method according to claim 1 further comprising:
converting the document to a non-editable form before or after adding the confidence mark.

4. A method according to claim 1 further comprising:
adding a second confidence mark to the document, with one mark indicating a creator or owner of the document, and the other mark indicating an entity that carries out the method on behalf of the owner.

5. A method according to claim 1 further comprising:
date/time stamping the document after authenticating each signature.

6. A method according to claim 1 further comprising:
encrypting the signed document before storing.

7. A method according to claim 1 further comprising:
signing the document with respect to a content owner before storing.

8. A method according to claim 1 wherein:
the confidence mark is a digital watermark representing a creator or owner of the document.

9. A method according to claim 1 wherein:
the confidence mark is a digital watermark representing an entity that conducts the method on behalf a creator or owner of the document.

10. A method according to claim 1 wherein:
signature includes addition of a digital signature.

11. A method according to claim 1 wherein:
authentication includes verification of a digital signature.

12. A computer program adapted to perform all the steps of claim according to claim 1.

13. A computer readable medium containing program instructions for implementing a method according to claim 1.

14. A method of signing an electronic document, comprising:
receiving the document from an entity over a communication network,
extracting a confidence mark from the document,
verifying the confidence mark as indicating the origin of the document,
presenting a verification of the confidence mark to a participant signatory,
creating a digital signature of the participant, and
transmitting the signature to the entity.

15. A method according to claim 13, further comprising:
extracting a second confidence mark from the document,
verifying the second confidence mark, and thereby
obtaining an indication of both a creator or owner of the document and of the entity.

16. A computer readable medium containing program instructions for implementing a method according to claim 14.

17. A system of processing an electronic document for signature and authentication, comprising:
means for receiving a document to be signed by one or more parties,
means for adding a confidence mark to the document,
means for providing the marked document for the parties,
means for receiving and authenticating signatures of the parties to the marked document, and
means for storing the signed document.

18. A system according to claim 17 further comprising:
means for date/time stamping the document after receiving the document for signature.

19. A system according to claim 17 further comprising:
means for converting the document to a non-editable form before or after adding the confidence mark.

20. A system according to claim 17 further comprising:
means for adding a second confidence mark to the document, with one mark indicating a creator or owner of the document, and the other mark indicating an entity that carries out the system on behalf of the owner.

21. A system according to claim 17 further comprising:
means for date/time stamping the document after authenticating each signature.

22. A system according to claim 17 further comprising:
means for encrypting the signed document before storing.

23. A system according to claim 17 further comprising:
means for signing the document with respect to a content owner before storing.

24. A system according to claim 17 wherein:
the means for adding a confidence mark creates a digital watermark representing a creator or owner of the document.

25. A system according to claim 17 wherein:
the means for adding a confidence mark creates a digital watermark representing an entity that conducts the system on behalf a creator or owner of the document.

26. A system according to claim 17 wherein:
means for signing includes means for adding of a digital signature.

27. A system according to claim 17 wherein:
means for receiving and authentication includes means for verification of a digital signature.

28. A computer program adapted to perform all the steps of claim according to claim 17.

29. A computer readable medium containing program instructions for implementing a system according to claim 17.

30. A system of signing an electronic document, comprising:
means for receiving the document from an entity over a communication network,
means for extracting a confidence mark from the document,
means for verifying the confidence mark as indicating the origin of the document,
means for presenting a certification of the confidence mark to a participant signatory,
means for creating a digital signature of the participant, and
means for transmitting the signature to the entity.

31. A system according to claim 29, further comprising:
means for extracting a second confidence mark from the document,
